(19) United States
(12) Patent Application Publication
(10) Pub. No.: US 2022/0288717 A1
(43) Pub. Date: Sep. 15, 2022

(54) PIPE WELDING RING AND PIPE WELDING METHOD USING THE SAME

(71) Applicant: Hwasung Engineering Co., Ltd., Seoul (KR)

(72) Inventors: DO HYUNG KIM, Seoul (KR); SUNG MOK RYU, Seoul (KR); BONG JU KIM, Seoul (KR)

(21) Appl. No.: 17/689,397

(22) Filed: Mar. 8, 2022

(30) Foreign Application Priority Data
Mar. 9, 2021 (KR) 10-2021-0030930

(51) Int. Cl. B23K 9/32; B23K 37/02

(52) U.S. Cl. CPC B23K 9/32; B23K 37/0276; B23K 2101/04

(57) ABSTRACT

The present disclosure discloses a pipe welding ring and a pipe welding method using the same. The disclosed pipe welding ring is a plate-type welding ring which is disposed between two corresponding pipes to join the pipes, comes in contact with a welding surface of each of the pipes, and joins the pipes when melted by heating with a welding torch, and the disclosed pipe welding method includes a welding ring placing operation in which the welding ring is disposed between a first pipe and a second pipe to be joined with each other, a centering operation in which, while the center of the welding ring is aligned with the center of the first pipe and the second pipe, the first pipe and the second pipe are brought into close contact with the welding ring to support the welding ring, and a welding operation in which a welding torch is used to heat the welding ring.

### CROSS-REFERENCE TO RELATED APPLICATION

This application claims priority to and the benefit of Korean Patent Application No. 10-2021-0030930, filed on Mar. 9, 2021, the disclosure of which is incorporated herein by reference in its entirety.

### TECHNICAL FIELD

The present disclosure relates to a pipe welding ring and a pipe welding method using the same, and more particularly, to a pipe welding ring and a pipe welding method using the same capable of preventing deterioration of welding quality and allowing welding to be performed with uniform quality regardless of the worker's skill, thus improving the welding quality, and capable of forming a welding bead simultaneously on an outer surface and an inner surface of a pipe through a single welding process, thus reducing the welding process and time and improving workability.

### BACKGROUND OF THE INVENTION

Generally, various processes such as deposition, photolithography, etching, and cleaning are required to manufacture a semiconductor device, and chemicals necessary for each process are transferred by installing pipes.

Also, due to characteristics of semiconductor equipment, in order to install or repair pipes, work is directly performed inside a building where pipes are installed. Thus, various forms of safety devices are used to prevent the scattering of sparks that are generated in the process of welding the pipes.

For example, in some cases, a preventive cover for preventing the scattering of sparks is installed outside the pipes to be welded, and then the welding work is performed.

In recent years, a method in which a spark scattering prevention tool is directly attached to a pipe by being assembled thereto in order to perform welding has been mainly used.

However, the spark scattering prevention tool of the related art has problems in that its structure for installing on a pipe is very complex and it is large and heavy such that it is difficult for a worker to handle and install and its portability is significantly reduced.

### SUMMARY OF THE INVENTION

The present disclosure is directed to providing a pipe welding ring and a pipe welding method using the same capable of forming a welding bead simultaneously on an inner surface and an outer surface of a pipe during pipe welding, thus allowing pipe welding to be performed with one welding, and capable of performing welding without moving the welding ring in a state in which the welding ring is fixed to the pipe, thus implementing uniform, precise welding quality.

A pipe welding ring according to one aspect of the present disclosure is disposed between two corresponding pipes to join the pipes, comes in contact with a welding surface of each of the pipes, and joins the pipes when melted by heating with a welding means such as a welding torch.

In the present disclosure, the pipe welding ring may be formed in the shape of a plate-type ring of which both side surfaces come in contact with the welding surfaces for joining the pipes.

In the present disclosure, the pipe welding ring may include a first contact surface configured to come in contact with a first welding surface of a first pipe among the pipes and a second contact surface configured to come in contact with a second welding surface of a second pipe among the pipes.

In the present disclosure, a distance from an inner diameter to an outer diameter of the pipe welding ring may be formed to be larger than a thickness of the welding surface.

In the present disclosure, a height at which the pipe welding ring is exposed from an outer surface of the pipe may be in a range of 1.5 mm to 3 mm.

In the present disclosure, a thickness from the first contact surface to the second contact surface of the pipe welding ring may be in a range of 1.5 mm to 2.5 mm.

In the present disclosure, the first contact surface and the second contact surface of the pipe welding ring may come in surface contact with the welding surface.

In the present disclosure, the pipe welding ring may form a welding bead simultaneously on an inner surface and an outer surface of the pipe as an outer surface of the pipe welding ring is heated and melted with the welding means.

A pipe welding method using a welding ring according to another aspect of the present disclosure includes a welding ring placing operation in which the welding ring is disposed between a first pipe and a second pipe to be joined with each other, a centering operation in which, while the center of the welding ring is aligned with the center of the first pipe and the second pipe, the first pipe and the second pipe are brought into close contact with the welding ring to support the welding ring, and a welding operation in which a welding means is used to heat the welding ring.

In the present disclosure, in the welding ring placing operation, the welding ring may be formed in the shape of a plate-type ring having a first contact surface and a second contact surface.

In the present disclosure, in the welding ring placing operation, the first contact surface may be brought into contact with a first welding surface of the first pipe, and the second contact surface may be brought into contact with a second welding surface of the second pipe.

In the present disclosure, in the centering operation, alignment may be performed so that an inner diameter of the welding ring protrudes toward an inner side of the first pipe and the second pipe, and an outer diameter of the welding ring protrudes toward an outer side of the first pipe and the second pipe.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view for describing a pipe welding ring according to an embodiment of the present disclosure;

FIG. 2 is a perspective view showing an installation state of the pipe welding ring according to an embodiment of the present disclosure;

FIG. 3 is a cross-sectional view for describing the pipe welding ring according to an embodiment of the present disclosure;

FIG. 4 is an enlarged view of a main part for describing melting of the pipe welding ring according to an embodiment of the present disclosure;

FIG. 5 is an enlarged cross-sectional view of a main part for describing a molten state of the pipe welding ring according to an embodiment of the present disclosure; and

FIG. 6 is a flowchart for describing a pipe welding method using a welding ring according to an embodiment of the present disclosure.

While the disclosure is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the disclosure.

### DETAILED DESCRIPTION

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The device, apparatus and methods described herein should not be construed as limiting in any way. Instead, the present disclosure is directed toward all novel and non-obvious features and aspects of the various disclosed embodiments, alone and in various combinations and sub-combinations with one another. The disclosed devices, methods, and apparatus are not limited to any specific aspect or feature or combinations thereof, nor do the disclosed devices, methods, and apparatus require that any one or more specific advantages be present or problems be solved. Any theories of operation are to facilitate explanation, but the disclosed devices, methods, and apparatus are not limited to such theories of operation.

It is noted that references in the specification to “an embodiment”, “some embodiments”, “other embodiments”, etc., indicate that the embodiment described may include one or more particular features, structures, and/or characteristics. However, such recitations do not necessarily mean that all embodiments include the particular features, structures, and/or characteristics. Additionally, when particular features, structures, and/or characteristics are described in connection with one embodiment, it should be understood that such features, structures, and/or characteristics may also be used connection with other embodiments whether or not explicitly described unless clearly stated to the contrary.

Hereinafter, exemplary embodiments of a pipe welding ring and a pipe welding method using the same according to the present disclosure will be described with reference to the accompanying drawings. In this process, thicknesses of lines, sizes of elements, or the like that are illustrated in the drawings may have been exaggerated for clarity and convenience of description.

Also, the terms used herein are terms defined in consideration of functions in the present disclosure and may vary according to an intention or practice of a user or an operator. Therefore, the terms should be defined on the basis of the content throughout the specification.

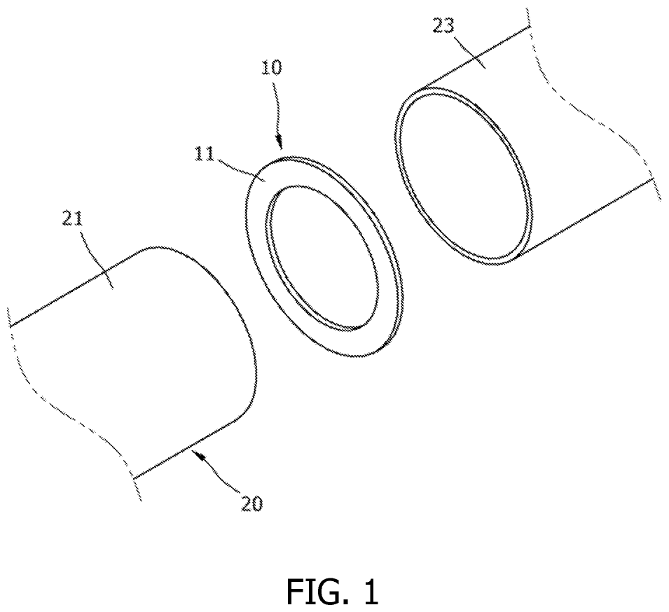

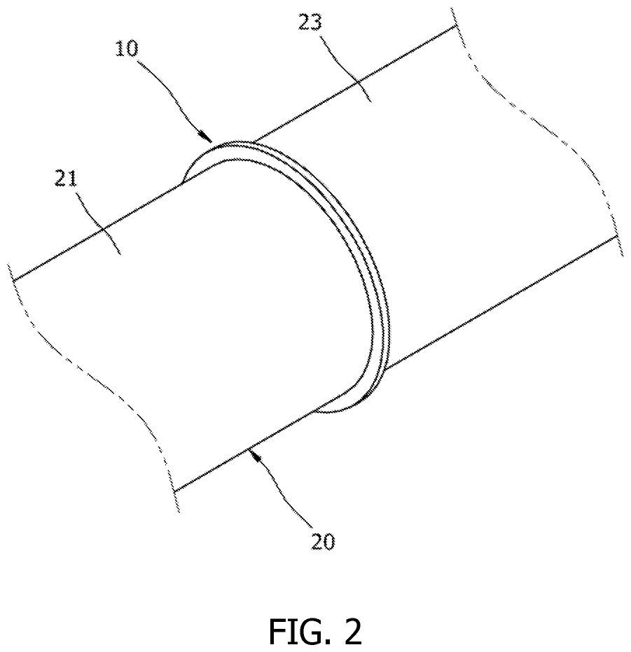

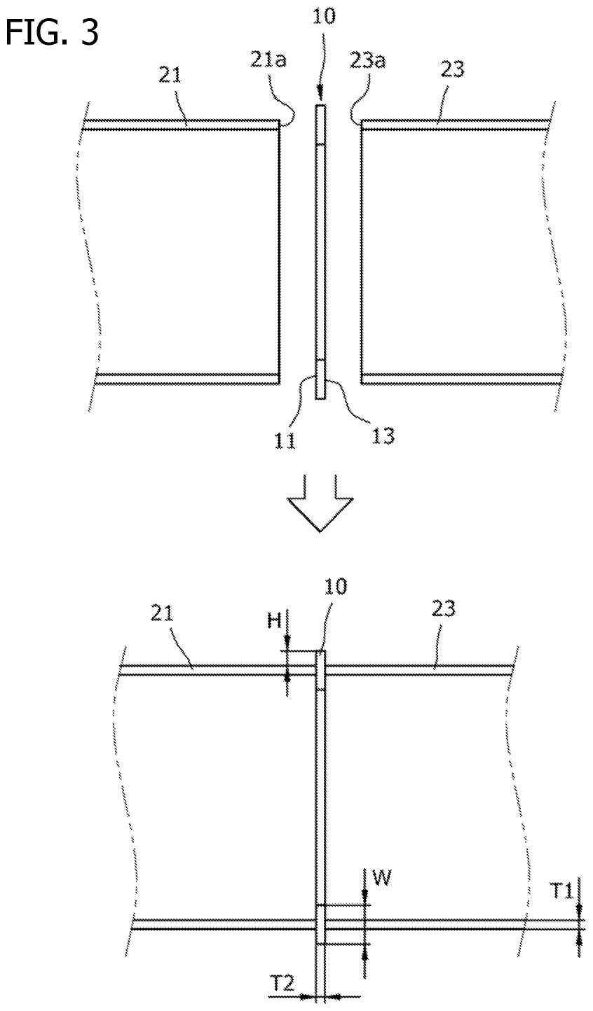

FIG. 1 is a perspective view for describing a pipe welding ring according to an embodiment of the present disclosure, FIG. 2 is a perspective view showing an installation state of the pipe welding ring according to an embodiment of the present disclosure, and FIG. 3 is a cross-sectional view for describing the pipe welding ring according to an embodiment of the present disclosure.

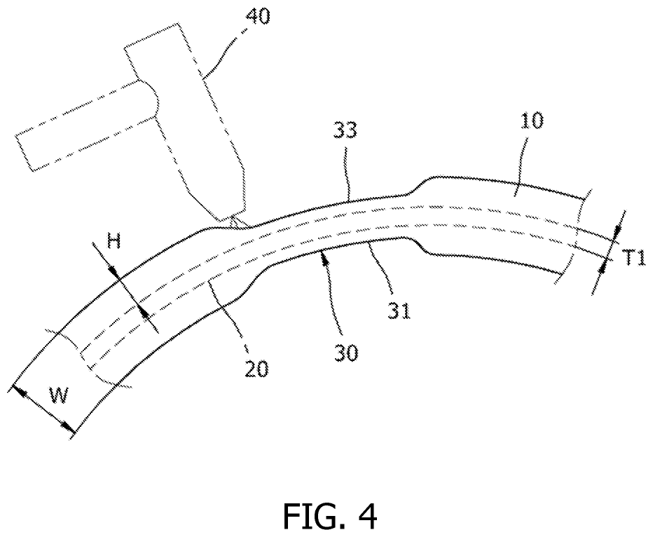

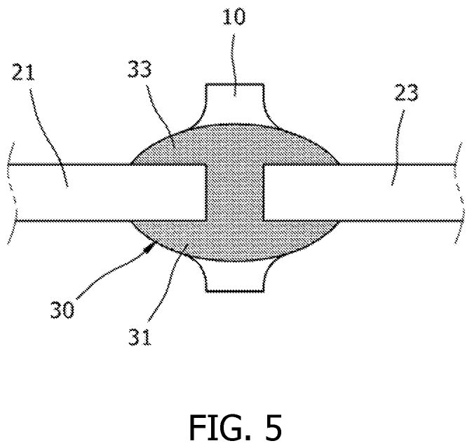

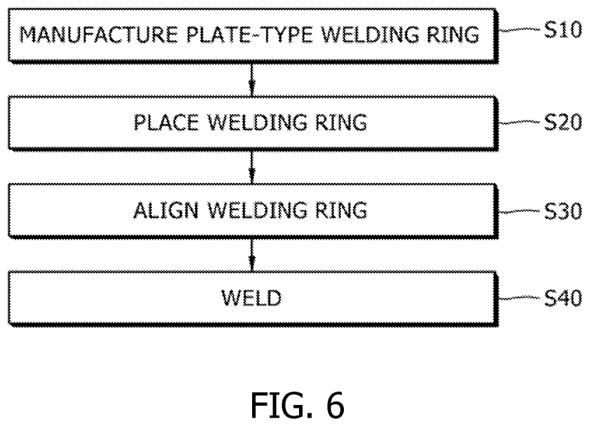

Also, FIG. 4 is an enlarged view of a main part for describing melting of the pipe welding ring according to an embodiment of the present disclosure, FIG. 5 is an enlarged cross-sectional view of a main part for describing a molten state of the pipe welding ring according to an embodiment of the present disclosure, and FIG. 6 is a flowchart for describing a pipe welding method using a welding ring according to an embodiment of the present disclosure.

A pipe welding ring according to an embodiment of the present disclosure will be described in detail with reference to FIGS. 1 to 5.

As illustrated in FIGS. 1 to 5, a pipe welding ring 10 according to the present embodiment is configured to implement uniform welding quality regardless of the worker's skill.

Specifically, the pipe welding ring 10 may be used in joining (welding) two pipes 20 to each other, especially when welding ends of a first pipe 21 and a second pipe 23. In particular, the pipe welding ring 10 according to the present embodiment is used in place of a welding rod in gas welding using a welding rod, e.g., argon welding or the like.

For example, in the related art, a welding rod should be placed between a first pipe 21 and a second pipe 23 to be joined with each other, and then while melting the welding rod with a welding means such as a welding torch and continuously moving the welding rod, the welding rod should be continuously uniformly supplied corresponding thereto. Thus, there may be a significant difference in welding quality due to the speed at which the welding rod is supplied and moved, the position of the welding rod, a welding angle, and the like, and the welding work should be performed two times in order to form a welding bead on an inner surface and an outer surface of the first pipe 21 and the second pipe 23.

On the other hand, when the pipe welding ring 10 according to the present disclosure is welded with a welding torch 40 without the use of a welding rod in a state in which the pipe welding ring 10 is in close contact with the first pipe 21 and the second pipe 23 while being placed therebetween, the pipe welding ring 10 allows welding beads 30 to be simultaneously formed on inner and outer surfaces of the first pipe 21 and the second pipe 23 just by one welding. Thus, not only is it possible to easily and promptly perform welding, but also uniform, precise welding quality may be implemented regardless of the worker's skill.

To this end, the pipe welding ring 10 according to the present embodiment is formed in the shape of a plate-type ring having a first contact surface 11 and a second contact surface 13 to respectively come in contact with welding surfaces 21a and 23a of the first pipe 21 and the second pipe 23 to be joined with each other. Here, the first pipe 21 and the second pipe 23 have the welding surface formed in the shape of a vertical plane to come in close surface contact with the first contact surface 11 and the second contact surface 13 of the pipe welding ring 10.

In the pipe welding ring 10, the first contact surface 11 comes in contact with a first welding surface 21a of the first pipe 21, and the second contact surface 13 comes in contact with a second welding surface 23a of the second pipe 23. Here, the first pipe 21 and the second pipe 23 are brought into close contact with each other using a jig or the like to prevent the pipe welding ring 10 disposed therebetween from being detached. In this way, it is possible to prevent not only the detachment of the pipe welding ring 10 but also movement of the pipe welding ring 10 during the welding work.

Also, in the pipe welding ring 10 according to the present embodiment, in order to allow an inner bead 31 and an outer bead 33 to be formed together during welding, a width W from an inner diameter to an outer diameter is formed to be larger than a thickness T1 of the first welding surface 21a and the second welding surface 23a, the inner diameter is exposed toward an inner side of the first pipe 21 and the second pipe 23, and the outer diameter is exposed toward an outer side of the first pipe 21 and the second pipe 23.

Specifically, the width W from the inner diameter to the outer diameter of the pipe welding ring 10 is formed to be in a range of 6 mm to 6.5 mm, and the pipe welding ring 10 is fixed between the first pipe 21 and the second pipe 23 so that a height H at which the pipe welding ring 10 is exposed from an outer surface of the first pipe 21 and the second pipe 23 is 1.5 mm or more.

In the present embodiment, the height H at which the pipe welding ring 10 is exposed from the outer surface of the first pipe 21 and the second pipe 23 may be in a range of 1.5 mm to 3 mm, and the width W may also vary according to the thickness T1 of the first pipe 21 and the second pipe 23.

In addition, in the pipe welding ring 10, a thickness T2 from the first contact surface 11 to the second contact surface 13 may be formed to be in a range of 1.5 mm to 2.5 mm.

Meanwhile, the pipe welding ring 10 according to the present embodiment may be manufactured using stainless steel, e.g., STS304, and may be deformed according to a welding method and a material of the pipes 20 to be welded.

Unlike the conventional welding rod, the pipe welding ring 10 according to the present disclosure that is configured as above allows welding to be performed without being moved in a state of being fixed between the welding surfaces 21a and 23a of the first pipe 21 and the second pipe 23. Thus, it is possible to implement uniform welding quality regardless of the worker's skill.

Also, the pipe welding ring 10 according to the present disclosure has an outer surface heated by the welding torch 40 and is simultaneously melted from the outer surface to inner surface. Thus, the welding beads 30 are simultaneously formed on the outer surface and inner surface of the pipe 20 by one welding process. Therefore, the welding process and time may be reduced, and workability may be improved.

A pipe welding method using the pipe welding ring according to an embodiment of the present disclosure configured as above will be described.

Referring to FIGS. 1 to 6, a pipe welding method using a welding ring according to an embodiment of the present disclosure includes a welding ring manufacturing operation (S10) in which the plate-type welding ring 10 is manufactured, a welding ring placing operation (S20) in which the welding ring 10 is disposed between the first pipe 21 and the second pipe 23 to be joined with each other, a centering operation (S30) in which the welding ring 10 is placed at the center of the first pipe 21 and the second pipe 23, and a welding operation (S40) in which the welding torch 40 is used to weld the welding ring 10.

In the welding ring manufacturing operation (S10), the welding ring 10 having the first contact surface 11 and the second contact surface 13 is manufactured in the shape of a plate. Specifically, in the welding ring manufacturing operation (S10), the welding ring 10 whose width W from the inner diameter to the outer diameter is in a range of 6 mm to 6.5 mm and whose thickness T2 from the first contact surface 11 to the second contact surface 13 is in a range of 1.5 mm to 2.5 mm is manufactured.

Also, in the welding ring placing operation (S20), the plate-type welding ring 10 having the specific width W and thickness T2 is placed between the welding surfaces 21a and 23a of the first pipe 21 and the second pipe 23 to be welded to each other, and the first pipe 21 and the second pipe 23 are brought into close contact with the welding ring 10. Then, the first contact surface 11 comes in close contact with the first welding surface 21a of the first pipe 21, and the second contact surface 13 comes in close contact with the second welding surface 23a of the second pipe 23.

Then, in the centering operation (S30), using a jig or the like, the center of the plate-type welding ring 10 is aligned with the center of the first pipe 21 and the second pipe 23 to precisely maintain the height H at which the outer diameter of the plate-type welding ring 10 is exposed toward the outer side of the first pipe 21 and the second pipe 23 and a length at which the inner diameter of the plate-type welding ring 10 protrudes toward the inner side of the first pipe 21 and the second pipe 23.

Here, the plate-type welding ring 10 is precisely aligned so that the height H at which the plate-type welding ring 10 is exposed toward the outer side of the first pipe 21 and the second pipe 23 is in a range of 1.5 mm to 3 mm.

Next, in the welding operation (S40), purging equipment for creating a welding environment for the first pipe 21 and the second pipe 23 and a preventive cover for preventing scattering of sparks are installed, and then the welding torch 40 is used to melt the plate-type welding ring 10.

Then, the welding ring 10 simultaneously melts inside and outside the first pipe 21 and the second pipe 23, and the welding beads 30 are simultaneously formed on the inner and outer surfaces of the first pipe 21 and the second pipe 23. In this way, since the inner bead 31 and the outer bead 33 are simultaneously formed on the inner surface and outer surface of the pipe 20 just by one welding work, the welding work may be easily and promptly performed. Also, since the welding ring 10 may be provided as a fixed type instead of a moving type that moves together with the welding torch 40 according to movement thereof, any worker is able to implement uniform, precise welding quality regardless of his or her skill.

A case where a worker directly welds the welding ring 10 using the welding torch 40 in the welding operation (S40) according to the present embodiment has been described as an example, but welding may also be performed using a welding tool as necessary.

As described above, unlike the related art, a pipe welding ring and a pipe welding method using the same according to one aspect of the present disclosure allow welding to be performed in a state in which a welding ring is fixed to a pipe. Thus, there is an effect of preventing deterioration of welding quality and allowing welding to be performed with uniform quality regardless of the worker's skill.

Also, according to the present disclosure, an inner bead and an outer bead (welding beads) are simultaneously formed on an outer surface and an inner surface of the pipe just by one welding and fixing performed on an outer diameter of the welding ring. Thus, not only is it possible to significantly reduce the welding time, but also there is an effect of providing uniform inner bead quality.

The present invention is not limited to the exemplary embodiments described above and can be modified into various different forms, and it can be understood by those of ordinary skill in the art to which the present invention pertains that the exemplary embodiments can be implemented in other specific forms without changing the technical spirit or essential features of the present invention. Therefore, it should be understood that the exemplary embodiments described above are exemplary in all respects and not restrictive.

Those of ordinary skill in the art to which the present invention pertains should understand that the present invention may be practiced in other specific forms without changing the technical idea or essential features thereof. Therefore, the embodiments described herein should be understood as illustrative in all aspects, instead of limiting. The scope of the present invention is defined by the claims below rather than the detailed description above. The meaning and scope of the claims and all changes or modifications derived from their equivalents should be interpreted as falling within the scope of the present invention.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments. The invention's scope is, of course, defined in the language in which the appended claims are expressed.

What is claimed is:

1. A pipe welding ring which is disposed between a first pipe and a second pipe to be joined with each other and is formed in a circular shape to come in contact with a first welding surface of the first pipe and a second welding surface of the second pipe, the pipe welding ring comprising, in order to join the first pipe and the second pipe with each other when melted by heating with a welding means:
a first contact surface configured to come in surface contact with the first welding surface of the first pipe; and
a second contact surface configured to come in surface contact with the second welding surface of the second pipe,
wherein the pipe welding ring is formed in the shape of a plate-type ring in contact with the first welding surface and the second welding surface, respectively, for welding thereof and a distance from an inner diameter to an outer diameter of the pipe welding ring is formed to be larger than a thickness of the first welding surface and the second welding surface,
a height at which the pipe welding ring is exposed from an outer surface of the first pipe and the second pipe is in a range of 1.5 mm to 3 mm, and
a width (W) from the inner diameter to the outer diameter is formed to be in a range of 6 mm to 6.5 mm.

2. The pipe welding ring of claim 1, wherein a thickness from the first contact surface to the second contact surface is in a range of 1.5 mm to 2.5 mm.

3. A pipe welding method using a welding ring, the pipe welding method comprising:
a welding ring placing operation in which the welding ring of the claim 2 is disposed between a first pipe and a second pipe to be joined with each other;
a centering operation in which, while the center of the welding ring is aligned with the center of the first pipe and the second pipe, the first pipe and the second pipe are brought into close contact with the welding ring to support the welding ring; and
a welding operation in which a welding torch is used to heat the welding ring.

4. A pipe welding method using a welding ring, the pipe welding method comprising:
a welding ring placing operation in which the welding ring of claim 1 is disposed between a first pipe and a second pipe to be joined with each other;
a centering operation in which, while the center of the welding ring is aligned with the center of the first pipe and the second pipe, the first pipe and the second pipe are brought into close contact with the welding ring to support the welding ring; and
a welding operation in which a welding torch is used to heat the welding ring.

5. The pipe welding method of claim 4, wherein:
in the welding ring placing operation, the welding ring formed in the shape of a plate is brought into surface contact with a first welding surface of the first pipe and a second welding surface of the second pipe; and
in the centering operation, the welding ring formed in the shape of a plate is fixed so that an inner diameter of welding ring protrudes toward an inner side of the first pipe and the second pipe and an outer diameter thereof protrudes toward an outer side of the first pipe and the second pipe.

6. The pipe welding method of claim 3, wherein:
in the welding ring placing operation, the welding ring formed in the shape of a plate is brought into surface contact with a first welding surface of the first pipe and a second welding surface of the second pipe; and
in the centering operation, the welding ring formed in the shape of a plate is fixed so that an inner diameter of welding ring protrudes toward an inner side of the first pipe and the second pipe and an outer diameter thereof protrudes toward an outer side of the first pipe and the second pipe.
